(19) United States
(12) Patent Application Publication
(10) Pub. No.: US 2012/0306197 A1
(43) Pub. Date: Dec. 6, 2012

(54) COLLET FOR QUICK CONNECT TUBE COUPLING AND A MOLD APPARATUS FOR MAKING THE SAME

(76) Inventor: KUN-CHENG LIU, Taichung (TW)

(21) Appl. No.: 13/153,752

(22) Filed: Jun. 6, 2011

(51) Int. Cl. F16L 21/06; B29C 45/44

(52) U.S. Cl. 285/323; 425/577

(57) ABSTRACT

A collet includes an annular collar and four arms extending from the collar. Each arm has a reduced outer diameter arcuate section, an enlarged outer diameter arcuate section and a tapered arcuate section with a fan-shaped cross section at a distal end. Further, each arm has a first mold witness line presented on a boundary between the enlarged outer diameter arcuate section and the tapered arcuate section. Besides, each of two opposing ones of the four arms has its opposite side surfaces parallel to each other along its reduced outer diameter arcuate section and its enlarged outer diameter arcuate section. Each of the other two opposing ones of the four arms has a second mold witness line presented along its reduced outer diameter arcuate section and its enlarged outer diameter arcuate section and terminating at the intersection with the first mold witness line.

### BACKGROUND OF INVENTION

1. Field of Invention

The present invention relates to a collet for use in a tube coupling for locking the tube in a coupling body and to a mold apparatus for making such collet.

2. Related Prior Art

A conventional collet for use in a tube coupling generally includes an annular collar and a plurality of circumferential arms for encircling a tube pushed into a coupling body. U.S. Pat. No. 7,422,248 is exemplary of patents directed to a collet of the type to which this invention is directed.

FIGS. 11-20 illustrate another example of a collet 8 and a mold apparatus 9 for making the same. As shown in FIG. 11, the collet 8 includes an annular collar 81 and four arms 82a, 82b extending from the collar 81 in a direction generally parallel to the axis of the collar 81. The four arms 82a, 82b are arranged in a circle and spaced a distance apart by slots 83 for encircling a tube pushed in a coupling body.

To shape the collet 8, the mold apparatus 9 generally includes an upper male mold segment 91, a lower female mold segment 92 and two side mold segments 93, 94. As best seen in FIG. 13, the upper male mold segment 91 has a base 910 and a mold core 911 extending from a bottom of the base 910. The base 910 defines an annular groove 912 surrounding the mold core 911. As shown in FIGS. 11 and 15, the lower female mold segment 92 has a central circular stage 920 to be coupled with the mold core 911 of the male mold segment 91, and four circular-arc-shaped grooves 922 defined in a top surface 923 thereof surrounding the central circular stage 920. As shown in FIG. 11, the four circular-arc-shaped grooves 922 are separated by four partitions 921 which project outside the top surface 923 of the lower female mold segment 92. Moreover, for tightly gripping the tube, four arc-shaped metal strips 7 are disposed at a periphery of the central circular stage 920 of the female mold segment 92 and each is arranged between two of the four partitions 921.

Referring again to FIG. 11, the two side mold segments 93, 94 are disposed in between the upper and lower mold segments 91, 92 to be coupled to define a passage 934 therebetween for reception of the mold core 911 of the upper female mold segment 91. A top view of the two coupled side mold segments 93, 94 is shown in FIG. 12 with the collet 8 enclosed therebetween. FIG. 13 illustrates that the upper male mold segment 91 moves downward to couple with the lower female mold segment 92 and the two opposing side mold segments 93, 94, which are attached to the bottom of the male mold segment 91, move in slightly oblique direction downward and laterally toward each other. FIG. 14 illustrates the closed mold apparatus 9 along line 14-14 of FIG. 12. It is noted that when the four mold segments 91-94 come together, as depicted in FIGS. 14 and 15, a clearance 980 exists between the outer periphery of the mold core 911 and the inner periphery of the two side mold segments 93, 94 so as to define an injection region therebetween for forming of the collet 8.

Specifically, as shown in FIGS. 12 and 14, the two side mold segments 93, 94 have four ribs 935 radially projected toward the central line of the passage 934 to be in contact with the outer periphery of the mold core 911 of the male mold segment 91 and axially aligned with the four partitions 921 of the lower female mold segment 92. However, since the partitions 921 are projected outside the top surface 923 of the female mold segment 92, the partitions 921 may be badly hit by the two side mold segments 93, 94 while mold closing, if not careful, and therefore the mold apparatus 9 may be damaged or broken and end up with a short lifespan.

FIG. 16 illustrates a collet product 8 made from the mold apparatus 9. The collet 8 has the four arms 82a, 82b each having a reduced outer diameter arcuate section 821a or 821b, an enlarged outer diameter arcuate section 822 and a tapered arcuate section 823. FIG. 17 is a cross section of the collet 8 of FIG. 16. FIGS. 18-20 are three radial cross sectional views of the collet 8 along lines 18-18, 19-19 and 20-20 of FIG. 17. The four arms 82a, 82b of the collet 8 are substantially identical to one another except that two opposing ones 82a of the four arms have their reduced outer diameter arcuate sections 821a slightly different from that 821b of the other two arms 82b.

The difference is that the reduced outer diameter arcuate sections 821a of each of the first two arms 82a has an arch-shaped radial cross-section with two opposite sides parallel to each other, as depicted in FIG. 18, while the reduced outer diameter arcuate sections 821b of each of the other two arms 82b has a fan-shaped radial cross-section with two divergent sides. As shown in FIG. 18, a gap G1 is defined between adjacent two of the reduced outer diameter arcuate sections 821a, 821b as a result of the ribs 935 of the two side mode segments 93, 94, as depicted in FIG. 12.

FIG. 19 illustrates that the enlarged outer diameter arcuate sections 822 of each of the four arms 82a, 82b is identical to one another and has a fan-shaped radial cross-section. A gap G2 between adjacent two of the enlarged outer diameter arcuate section 822 is shaped from an upper projected part of each of the partitions 921 of the female mold segment 92 while molding, as depicted in FIG. 14. In other words, it is the upper projected parts of the partitions 921 of the female mold segment 92 that turn out to be the gaps G2 between the enlarged outer diameter arcuate sections 822 after injection molding. FIG. 20 illustrates that each of the four tapered arcuate sections 823 are identical to one another and has a smaller fan-shaped radial cross-section. Additionally, a gap G3 between adjacent two of the tapered arcuate sections 823 is defined from a lower embedded part of the partition 921 that is under the top surface 923 of the female mold segment 92 and separates the circular-arc-shaped grooves 922.

Besides, as shown in FIG. 16, each of the four arms 82a, 82b has a first horizontal mold witness line 824 presented on a boundary of the enlarged outer diameter arcuate sections 822 and the tapered arcuate sections 823 due to a parting line defined in between the female mold segment 92 and the respective side mold segment 93 or 94 while molding. However, only the other two arms 82b each has a second vertical mold witness line 825 presented along the reduced outer diameter arcuate section 821b as well as the enlarged outer diameter arcuate section 822 and terminating at the intersection with the first mold witness line 824 due to a parting line defined in between the two side mold segments 93, 94 while molding.

### SUMMARY OF INVENTION

The present invention offers a novel solution to many of the aforementioned problems caused by the projected partitions of the lower female mold segment and is directed to a collet for locking a tube in a tube coupling body and a mold apparatus that has a longer lifespan for making the collet.

Specifically, the mold apparatus includes an upper male mold segment, a lower female mold segment and two side mold segments. The upper male mold segment has a base and a mold core extending from a bottom of the base. The lower female mold segment has a central circular stage corresponding to the mold core of the male mold segment. Four circular-arc-shaped grooves are defined surrounding the central circular stage and separated by four partitions. In particular, the top surfaces of the four partitions are in flash with other top surface of the lower female mold segment.

The two side mold segments are disposed in between the upper and lower mold segments and configured to be coupled with each other to co-define a passage therebetween for reception of the mold core of the upper male mold segment. A clearance exists between the outer periphery of the mold core and the inner periphery of the two side mold segments so as to define an injection region therebetween for forming of the collet. The two side mold segments have four ribs radially projected toward the central line of the passage to be in contact with the outer periphery of the mold core of the male mold segment and axially aligned with the partitions of the lower female mold segment. Each of the ribs of the side mold segments has its bottom surface flash with other bottom surfaces of the side mold segments.

As described above, no partitions are projected outside the top surface of the female mold segment. Thus, no partitions will get hit by the two side mold segments.

After injection molding, the collet is formed in one piece to include an annular collar and four arms. Each of the four arms has a reduced outer diameter arcuate section, a middle enlarged outer diameter arcuate section and a tapered arcuate section at a distal end. However, two opposing ones of the four arms are slightly different from the other two. Specifically, the enlarged outer diameter arcuate section of each of the two opposing arms has an arc-shaped radial cross-section with opposite sides parallel to each other, which differs from that of the prior art collet. In other words, each of the two arms has its head having two notches in the middle enlarged outer diameter arcuate section. Noted that it is the lower parts of ribs of the side mold segments, not the lower female mold segment, that turn out to be the notches of the collet after molding. Moreover, each of the four arms further has a first mold witness line presented on a boundary between the enlarged outer diameter arcuate section and the tapered arcuate section.

As for the other two of the four arms, the enlarged outer diameter arcuate section and the tapered arcuate section each has a radial fan-shaped cross-section. And, a second mold witness line is presented along the reduced outer diameter arcuate section and the enlarged outer diameter arcuate section and terminating at the intersection with the first mold witness line.

The construction of collet as well as the mold apparatus as described above is thus far largely conventional. According to the present invention, the configuration of mold apparatus employs a female mold segment with no projection theretop and therefore advantageously has a relatively long lifespan.

Further features and advantages of the present invention will be appreciated by review of the following detailed description of the invention.

### BRIEF DESCRIPTION OF DRAWINGS

The invention is illustrated by the accompanying drawings in which corresponding parts are identified by the same numerals and in which:

FIG. 1 is an exploded view of a collet and a mold apparatus in accordance with the preferred embodiment of the invention;

FIG. 2 is a top view of the collet enclosed by two side mold segments of the mold apparatus in FIG. 1;

FIG. 3 is a cross-sectional view of the mold apparatus of FIG. 1, showing that the mold segments are on the way to be coupled together;

FIG. 4 is a cross-sectional view of the mold apparatus taken along the line 4-4 of FIG. 2;

FIG. 5 is a cross-sectional view of the mold apparatus taken along the line 5-5 of FIG. 2;

FIG. 6 is an enlarged perspective view of the collet in FIG. 1;

FIG. 7 is an axial cross-sectional view of the collet of FIG. 6;

FIG. 8 is a radial cross-sectional view of the collet taken along the line 8-8 of FIG. 7;

FIG. 9 is a radial cross-sectional view of the collet taken along the line 9-9 of FIG. 7;

FIG. 10 is a radial cross-sectional view of the collet taken along the line 10-10 of FIG. 7;

FIG. 11 is an exploded view of a prior art collet and a prior art mold apparatus;

FIG. 12 is a top view of the prior art collet and two side mold segments of the prior art mold apparatus of FIG. 11;

FIG. 13 is a cross-sectional view of the mold apparatus of FIG. 11, showing that the mold segments are on the way to be coupled together;

FIG. 14 is a cross-sectional view of the prior art mold apparatus taken along the line 14-14 of FIG. 12;

FIG. 15 is a cross-sectional view of the prior art mold apparatus taken along the line 15-15 of FIG. 12;

FIG. 16 is an enlarged perspective view of the prior art collet in FIG. 11;

FIG. 17 is an axial cross-sectional view of the prior art collet of FIG. 16;

FIG. 18 is a radial cross-sectional view of the prior art collet taken along the line 18-18 of FIG. 17;

FIG. 19 is a radial cross-sectional view of the prior art collet taken along the line 19-19 of FIG. 17;

FIG. 20 is a radial cross-sectional view of the prior art collet taken along the line 20-20 of FIG. 17;

### DETAILED DESCRIPTION OF PREFERRED EMBODIMENT

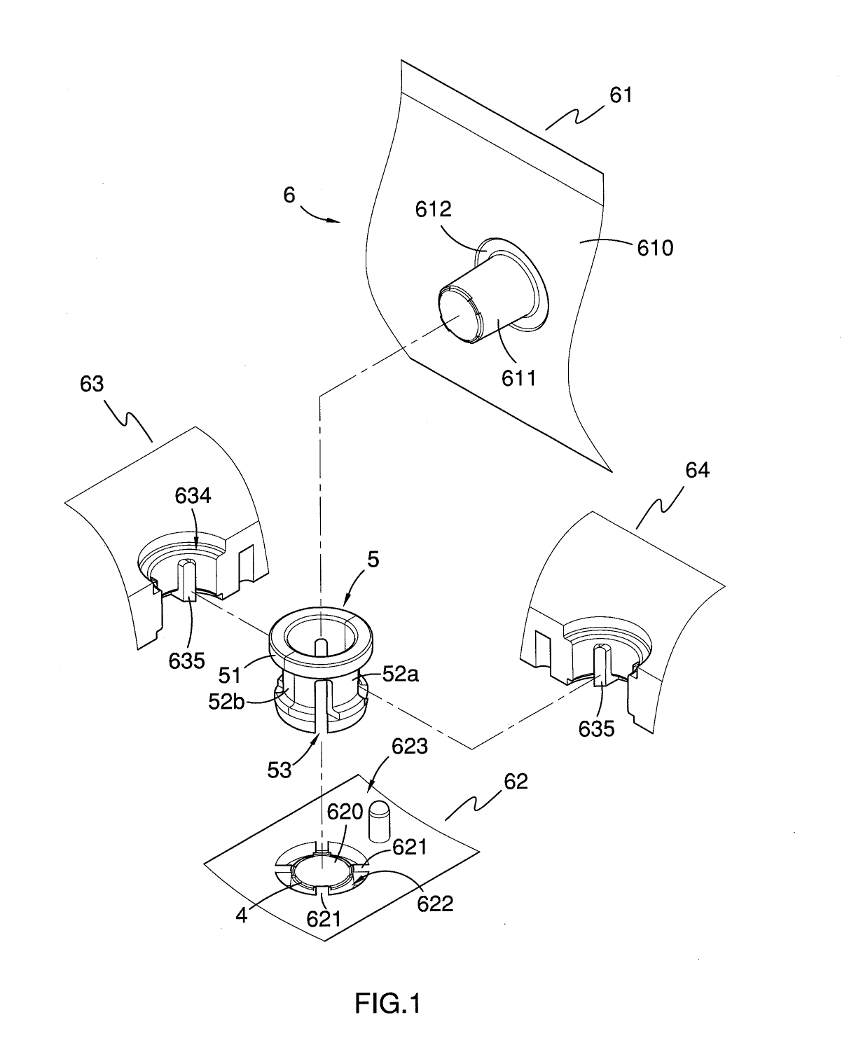

Referring now to FIGS. 1 through 10 of the drawings, there are shown a collet 5 and a mold apparatus 6 in accordance with the preferred embodiment of the invention. The collet 5 is molded in one piece from plastic for locking a tube in a tube coupling body (not shown) and generally includes an annular collar 51 and four arms 52a, 52b extending from the collar 51 in a direction generally parallel to the axis of the collar 51. The four arms 52a, 52b are arranged in a circle and spaced a distance apart from one another by slots 53 for encircling the tube. The four arms 52a, 52b are composed of two pairs of arms 52a, 52b that are quite different from each other, as will be discussed later in detail.

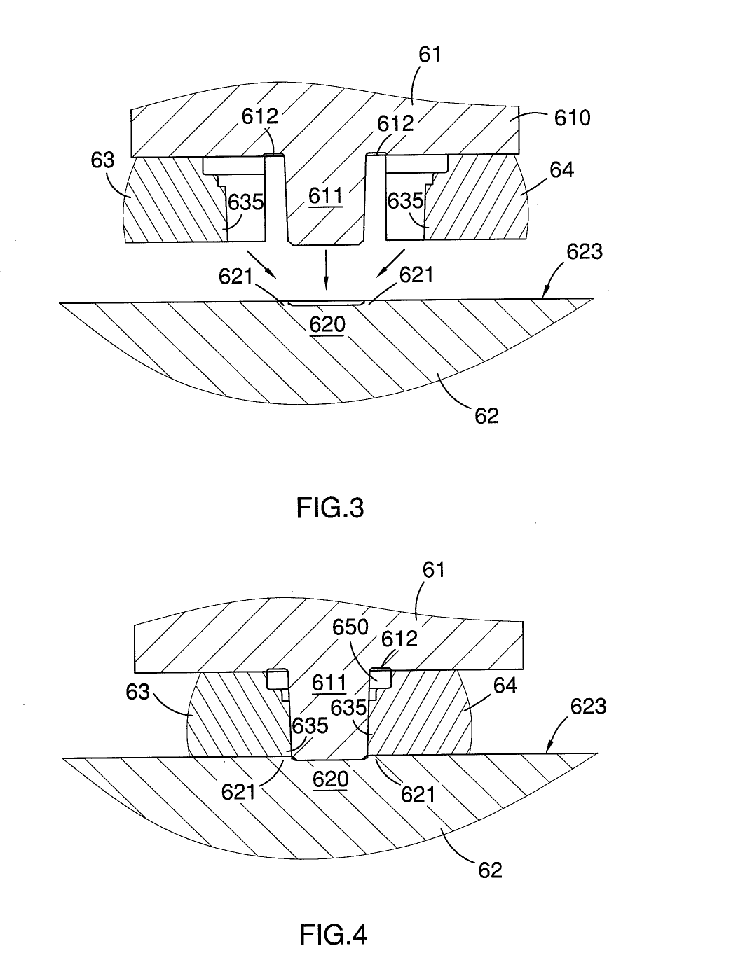

To shape this type of collet 5, the mold apparatus 6 generally includes an upper male mold segment 61, a lower female mold segment 62 and two side opposing mold segments 63, 64. As shown in FIGS. 1 and 3, the upper male mold segment 61 has a base 610 and a mold core 611 extending from a bottom of the base 610. An annular groove 612 is defined around the mold core 611. As shown in FIGS. 1 and 5, the lower female mold segment 62 has a central circular stage 620 to be coupled with the mold core 611 of the male mold segment 61, and four circular-arc-shaped grooves 622 defined in a top surface thereof surrounding the central circular stage 620. As shown in FIG. 1, the four circular-arc-shaped grooves 622 are separated by four partitions 621 which are in flash with the top surface 623 of the lower female mold segment 62, as depicted in FIG. 1. Additionally, to tightly grip the tube, four arc-shaped metal strips 4 are provided at a periphery of the central circular stage 620 of the female mold segment 62 and each is arranged in between two of the four partitions 621.

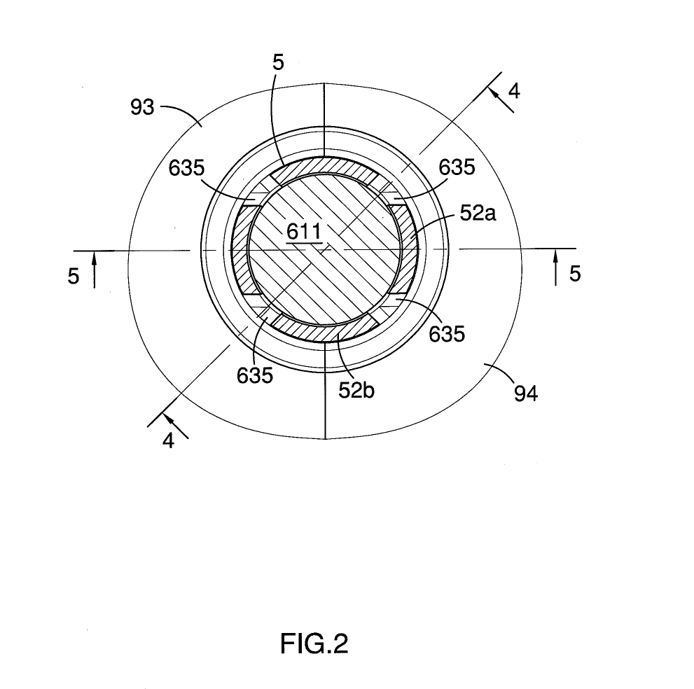

Referring again to FIG. 1, the two side mold segments 63, 64 are disposed in between the upper and lower mold segments 61, 62 and configured to be coupled with each other to define a passage 634 therebetween for reception of the mold core 611 of the upper male mold segment 61. A top view of the two coupled side mold segments 63, 64 is shown in FIG. 2 with the formed collet 5 enclosed therein. FIG. 3 illustrates that the upper male mold segment 61 moves downward to couple with the lower female mold segment 62 and the two opposing side mold segments 63, 64, which are attached to the bottom of the male mold segment 61, move in slightly oblique direction downward and laterally toward each other. FIG. 4 illustrates a cross section of the closed mold apparatus 6 along line 4-4 of FIG. 2. It is noted that when the four mold segments 61-64 come together, as depicted in FIGS. 4 and 5, a clearance 650 exists between the outer periphery of the mold core 611 of the male mold segment 61 and the inner periphery of the two side mold segments 63, 64 so as to define an injection region therebetween for forming of the collet 5.

Furthermore, as shown in FIGS. 2 and 4, the two side mold segments 63, 64 have four ribs 635 radially projected toward the central line of the passage 634 to be in contact with the outer periphery of the mold core 611 of the male mold segment 61 and axially aligned with the underneath partitions 621 of the lower female mold segment 62. Each of the ribs 635 of the side mold segments 63, 64 has its bottom surface flash with other bottom surfaces of the side mold segments 63, 64 to be coupled with the flat top surface 623 of the lower female mold segment 62, as depicted in FIG. 4.

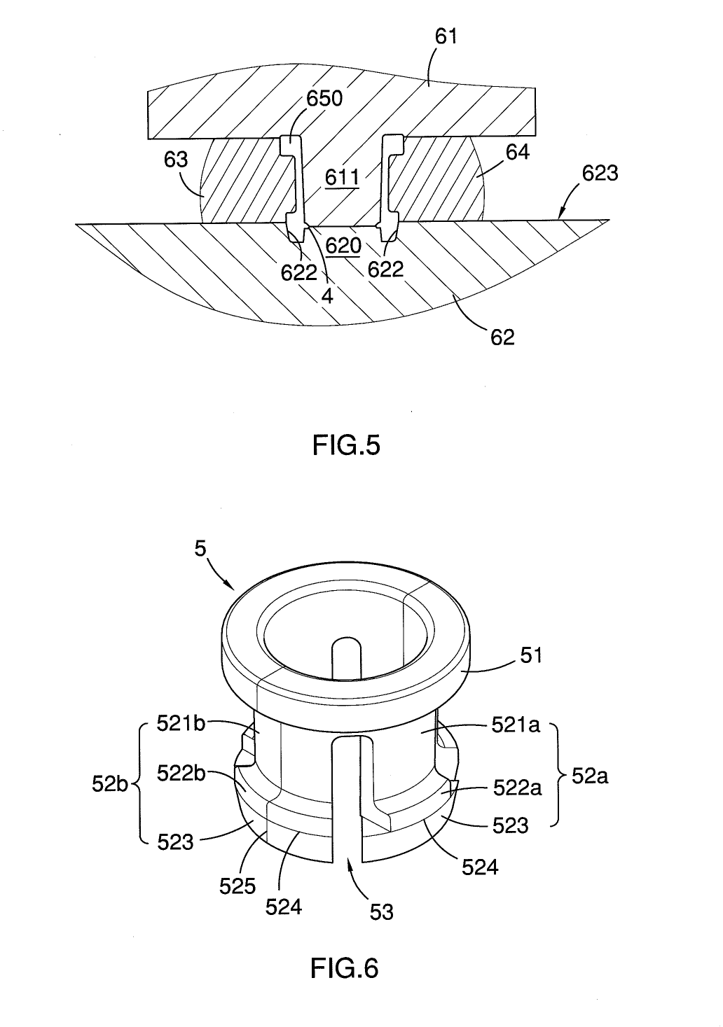

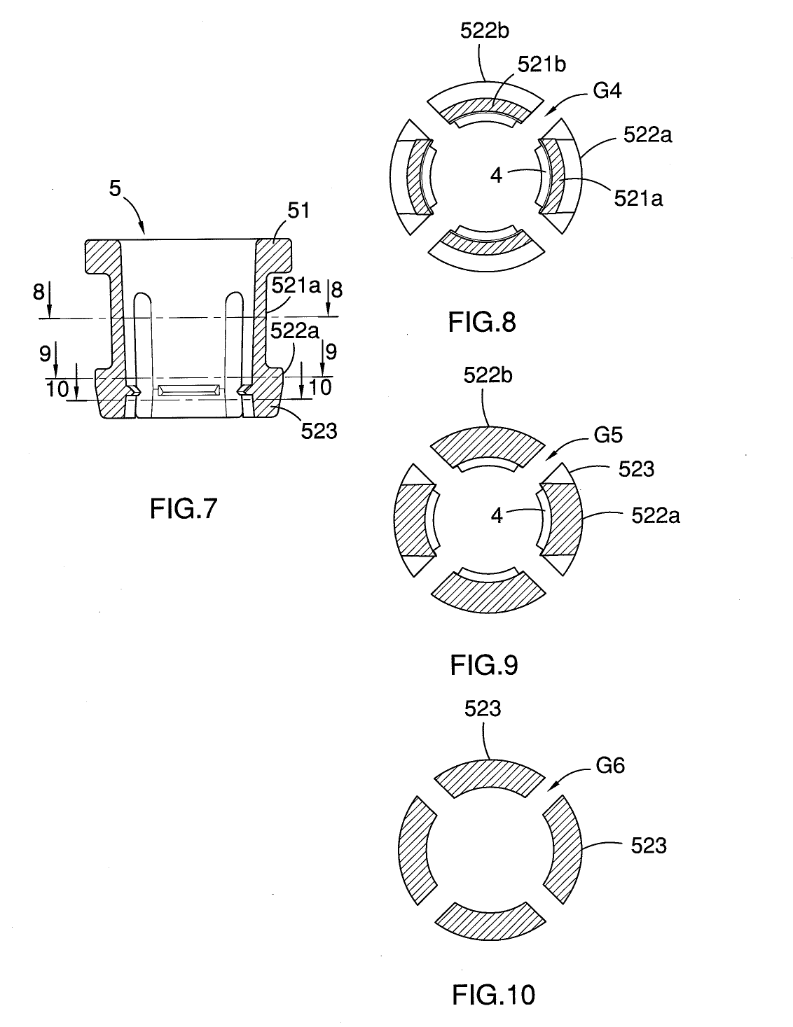

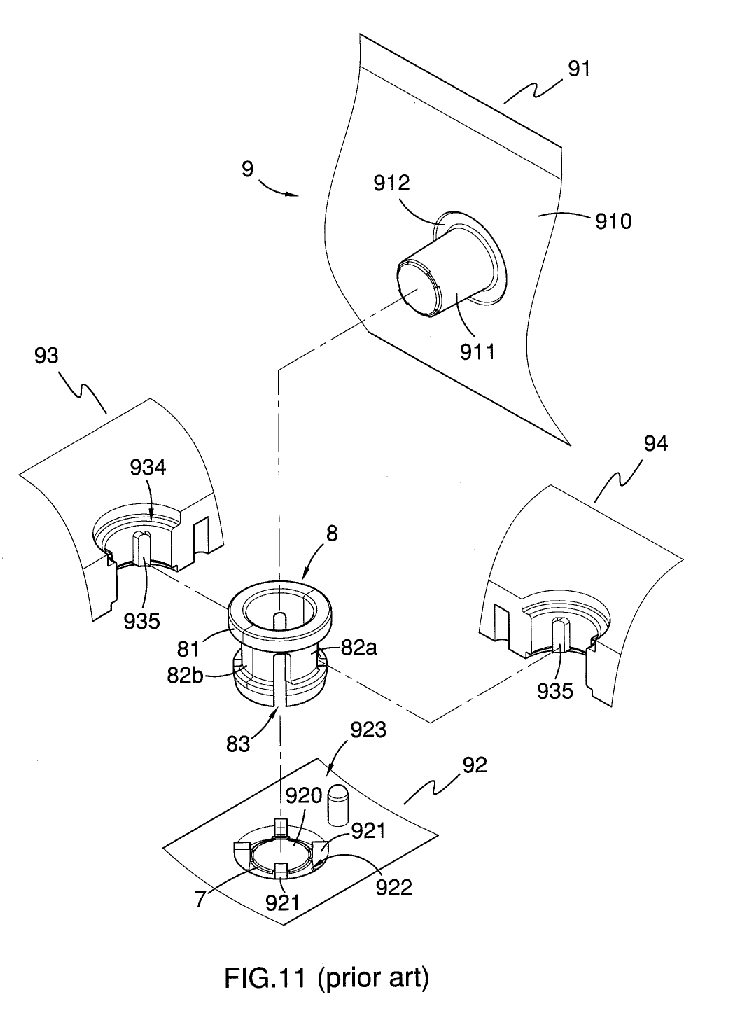

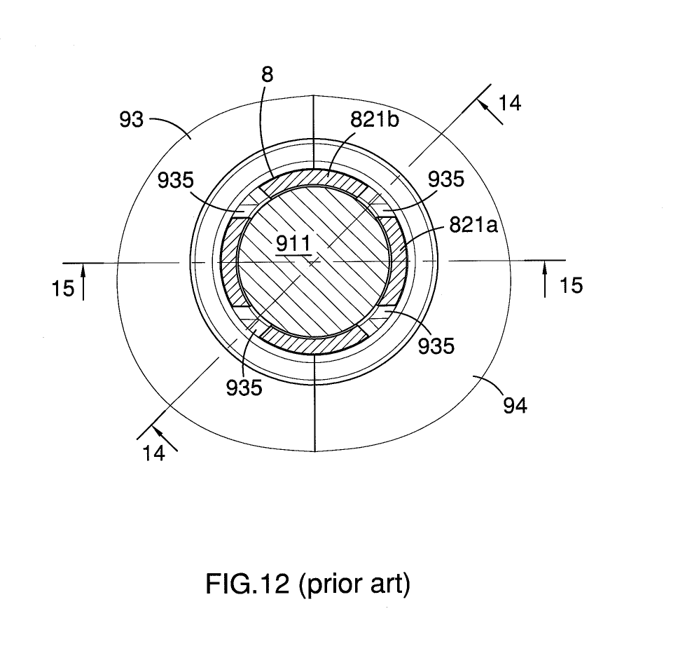

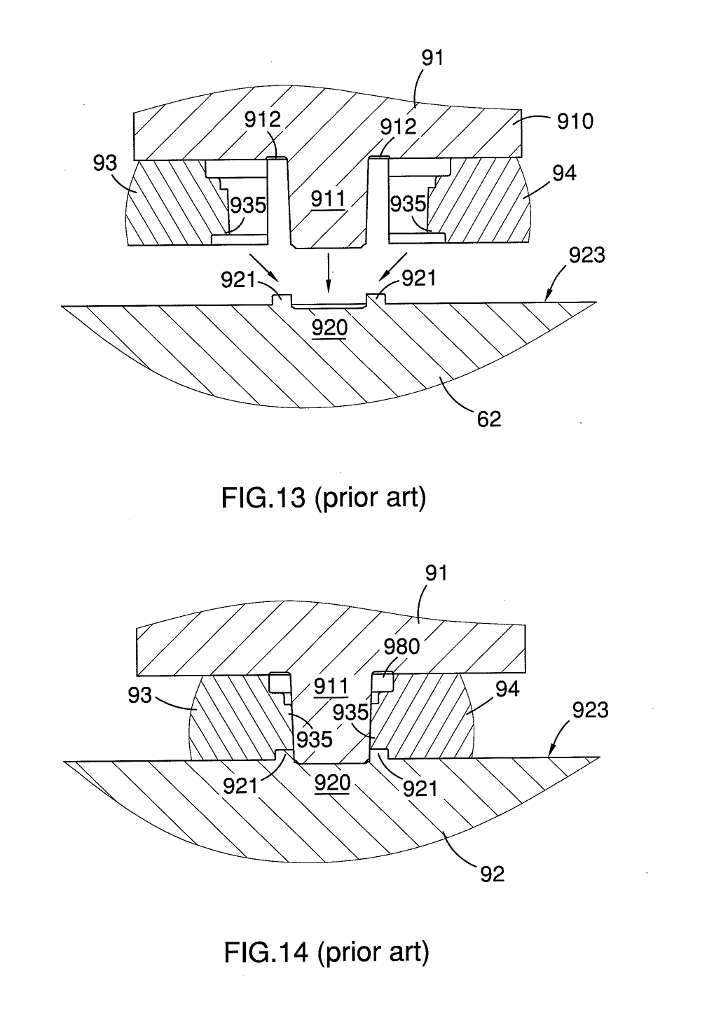

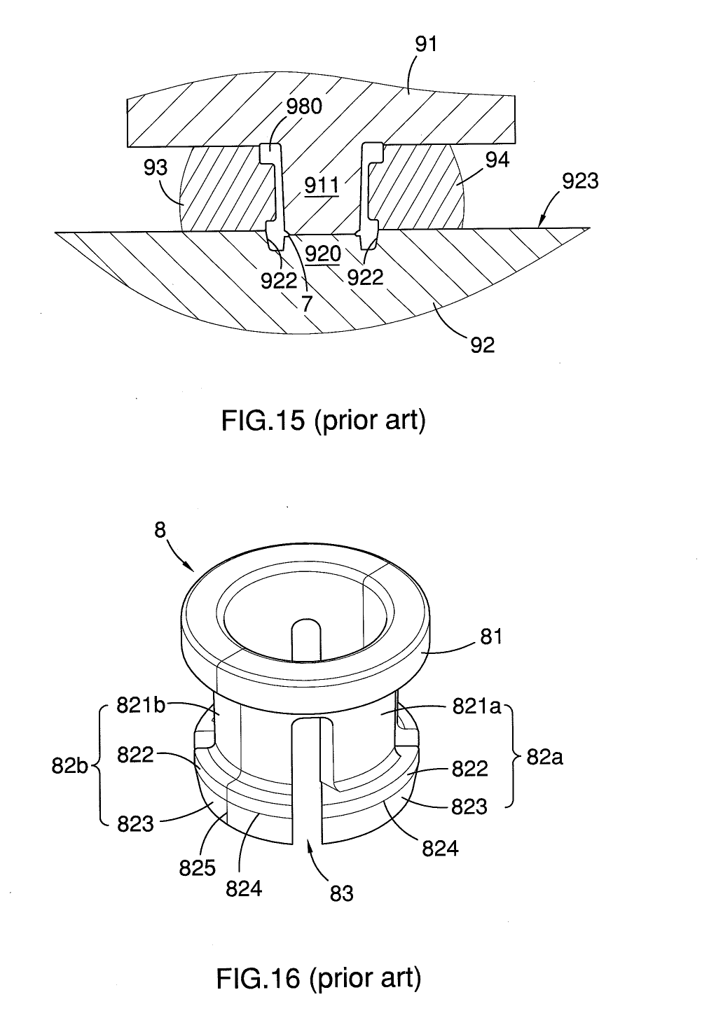

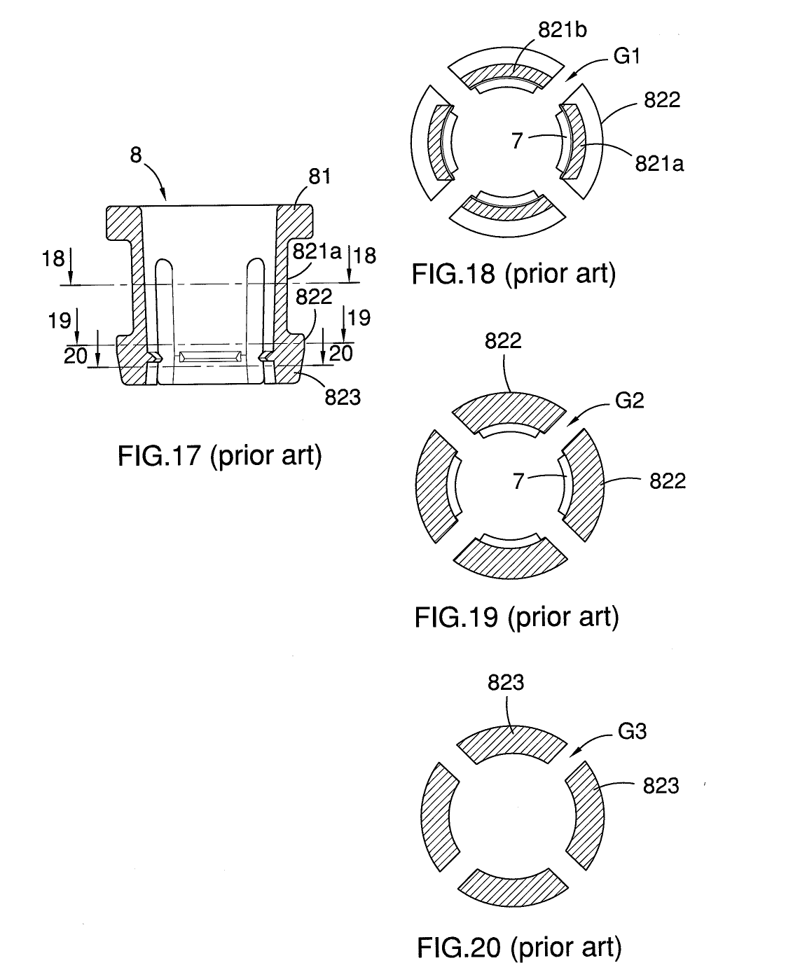

FIG. 6 illustrates a collet product 5 made from the mold apparatus 6. FIG. 7 is a cross section of the collet 5 in FIG. 6. FIGS. 8-10 are three radial cross sectional views of the collet 5 along lines 8-8, 9-9 and 10-10 of FIG. 7. As shown in FIG. 6, the collet 8 has the four arms 52a, 52b, and two opposing ones 52a of the four arms are different from the other two arms 52b.

As shown in FIGS. 6 and 7, each of the first pair of the arms 52a has a reduced outer diameter arcuate section 521a extending from the collar 51, an enlarged outer diameter arcuate section 522a extending from the reduced outer diameter arcuate section 521a and a tapered arcuate section 523 at a distal end. Likewise, the other two arms 52b each has a reduced outer diameter arcuate section 521b extending from the collar 51, an enlarged outer diameter arcuate section 522b extending from the reduced outer diameter arcuate section 521b and a tapered arcuate section 523 at a distal end.

As shown in FIG. 8, the reduced outer diameter arcuate sections 521a has an arch-shaped radial cross-section with two opposite sides parallel to each other while the other reduced outer diameter arcuate section 821b has a fan-shaped radial cross-section with two divergent sides. Moreover, a gap G4 is defined between adjacent two of the reduced outer diameter arcuate sections 821a, 821b as a result of an upper part of the rib 935 of the side mode segments 93 or 94, as depicted in FIGS. 1 and 4.

FIG. 9 illustrates that the enlarged outer diameter arcuate section 522a has an arc-shaped radial cross-section with opposite sides parallel to each other while the other enlarged outer diameter arcuate section 522b has a radial fan-shaped cross-section with two divergent sides. A gap G5 between adjacent two of the enlarged outer diameter arcuate sections 522a, 522b is shaped from a lower part of the rib 635 of the side mode segments 63 or 64, as depicted in FIGS. 1 and 4. In other words, it is the lower parts of the rib 635 of the side mode segments 63 and 64, rather than the partitions 621 of the female mold segment 62, that turn out to be the gaps G5 between the enlarged outer diameter arcuate sections 622 after injection molding.

FIG. 10 illustrates that each of the four tapered arcuate sections 523 of the four arms 52a, 52b are identical to one another and has a smaller fan-shaped radial cross-section. Additionally, a gap G6 between adjacent two of the tapered arcuate sections 523 is defined from the partition 621 of the female mold segment 62 that is in flash with the top surface 623 of the female mold segment 62 and separates the circular-arc-shaped grooves 622.

Besides, as shown in FIG. 6, each of the four arms 52a, 52b has a first horizontal mold witness line 524 presented on a boundary between the enlarged outer diameter arcuate section 522a or 522b and the tapered arcuate section 523 because of a parting line defined in between the side mold segment 63 or 64 and the underneath female mold segment 62 while injection molding. However, only two of the four arms 52b have the second vertical mold witness lines 525 each presented along the reduced outer diameter arcuate section 521b as well as the enlarged outer diameter arcuate section 522b and terminating at the intersection with the first mold witness line 524 due to a parting line defined in between the two side mold segments 63, 64 while injection molding.

Compared with FIGS. 4 and 14, it is understood that the ribs 635 of the side mold segments 63, 64 have an axial length greater than that of the ribs 935 of the prior art side mold segments 93, 94 so as to further define the gap G5. Additionally, the partitions 621 of the female mold segment 62 is in flash with other top surface 623 of the female mold segment 62 while the partitions 921 of the prior art female mold segment 92 are projected outside other top surface 923 of the female mold segment 92. Thus, there is no projections appearing on the female mold segment 62 and damages caused from hitting by the side mold segments 63, 64 may be avoided.

It will be appreciated that although a particular embodiment of the invention has been shown and described, modifications may be made. It is intended in the claims to cover such modifications which come within the spirit and scope of the invention.

The invention claimed is:

1. A molding apparatus for making of a collet, comprising:
an upper male mold segment having a base and a mold core extending from a bottom of said base;
a lower female mold segment having a central circular stage to be coupled with said mold core of said male mold segment and four circular-arc-shaped grooves surrounding said central circular stage and separated by four partitions; and said four partitions having their top surfaces flash with other top surface of said lower female mold segment; and
two side mold segments disposed in between said upper and lower mold segments and configured to be coupled with each other to co-define a passage therebetween for reception of said mold core of said upper male mold segment; a clearance existing between the outer periphery of said mold core and the inner periphery of said two side mold segments so as to define an injection region therebetween for forming of said collet; said two side mold segments having four ribs radially projected toward the central line of said passage to be in contact with the outer periphery of said mold core of said male mold segment and axially aligned with said partitions of said lower female mold segment; and each of said ribs of said side mold segments has its bottom surface flash with other bottom surfaces of said side mold segments.

2. A collet for locking a tube in a tube coupling body, said collet being molded in one piece and comprising an annular collar and four arms extending from said collar in a direction generally parallel to the axis of said collar;
each of two opposing ones of said four arms having a reduced outer diameter arcuate section extending from the collar, an enlarged outer diameter arcuate section extending from said reduced outer diameter arcuate section and a tapered arcuate section at a distal end; said enlarged outer diameter arcuate section having an arc-shaped radial cross-section with opposite sides parallel to each other, and said tapered arcuate section having a fan-shaped radial cross-section; each said arm further having a first mold witness line presented on a boundary between said enlarged outer diameter arcuate section and said tapered arcuate section;
each of the other two of said four arms being opposite to each other and having a reduced outer diameter arcuate section from the collar, an enlarged outer diameter arcuate section extending from said reduced outer diameter arcuate section and a tapered arcuate section at a distal end; said enlarged outer diameter arcuate section and said tapered arcuate section each having a radial fan-shaped cross-section; and each said arm further having a first mold witness line presented on a boundary between said enlarged outer diameter arcuate section and said tapered arcuate section, and a second mold witness line presented along said reduced outer diameter arcuate section and said enlarged outer diameter arcuate section in a direction generally parallel to the axis of said collar and terminating at the intersection with said first mold witness line.
